(19) United States
(12) Patent Application Publication
(10) Pub. No.: US 2018/0313494 A1
(43) Pub. Date: Nov. 1, 2018

(54) Vehicle Lifting System

(71) Applicant: Dennis Domsic, Watsonville, CA (US)

(72) Inventor: Dennis Domsic, Watsonville, CA (US)

(21) Appl. No.: 15/498,745

(22) Filed: Apr. 27, 2017

(51) Int. Cl. F16M 11/32; F16M 11/20; B62H 3/06

(52) U.S. Cl. CPC F16M 11/32; F16M 2200/028; B62H 3/06; F16M 11/2085

(57) ABSTRACT

A vehicle lifting system for lifting a vehicle includes a jack that is positioned on a support surface thereby facilitating the jack to be positioned beneath a vehicle. The jack is selectively urged between a lifted position and a lowered position. A mounting unit is removably coupled to the jack. A pair of lifting units is provided and each of the lifting units is removably coupled to the mounting unit. Each of the lifting units engages an associated pair of wheels on the vehicle thereby facilitating the pair of lifting units to lift the vehicle when the jack is urged into the lifting position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to lifting devices and more particularly pertains to a new lifting device for lifting a vehicle.

### BRIEF SUMMARY OF THE INVENTION

An embodiment of the disclosure meets the needs presented above by generally comprising a jack that is positioned on a support surface thereby facilitating the jack to be positioned beneath a vehicle. The jack is selectively urged between a lifted position and a lowered position. A mounting unit is removably coupled to the jack. A pair of lifting units is provided and each of the lifting units is removably coupled to the mounting unit. Each of the lifting units engages an associated pair of wheels on the vehicle thereby facilitating the pair of lifting units to lift the vehicle when the jack is urged into the lifting position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a mounting unit and a lifting unit of a vehicle lifting system according to an embodiment of the disclosure.

FIG. 2 is a disassembled view of a mounting unit and a lifting unit of an embodiment of the disclosure.

FIG. 3 is an exploded perspective view of mounting unit and a lifting unit of an embodiment of the disclosure.

FIG. 4 is a front in-use view of an embodiment of the disclosure.

FIG. 5 is a perspective in-use view of an embodiment of the disclosure.

### DETAILED DESCRIPTION OF THE INVENTION

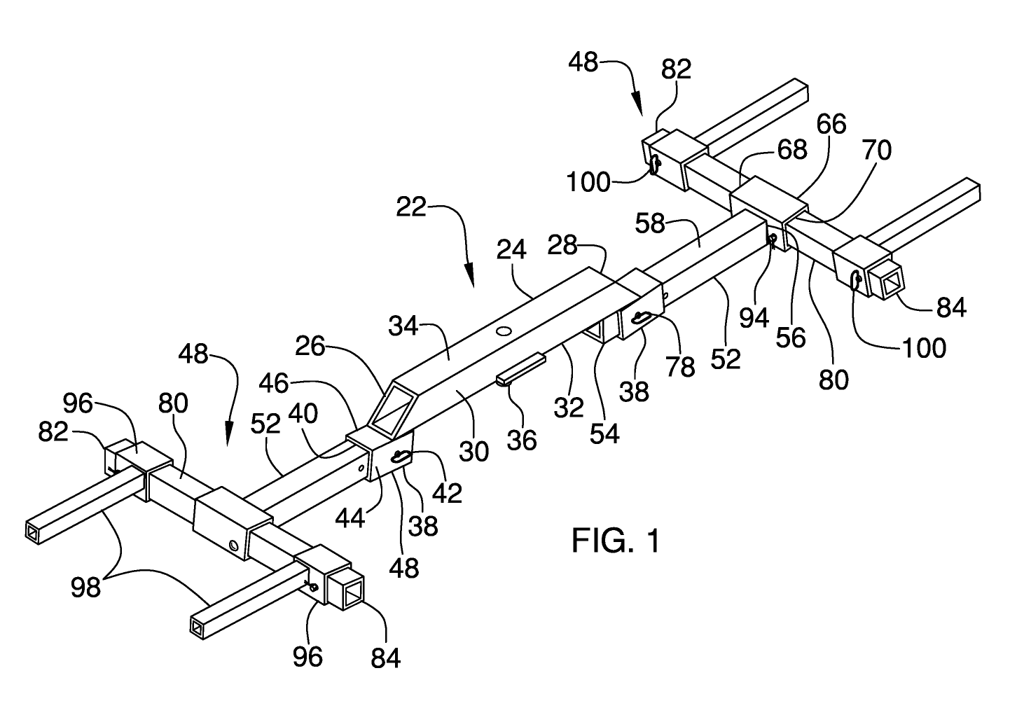

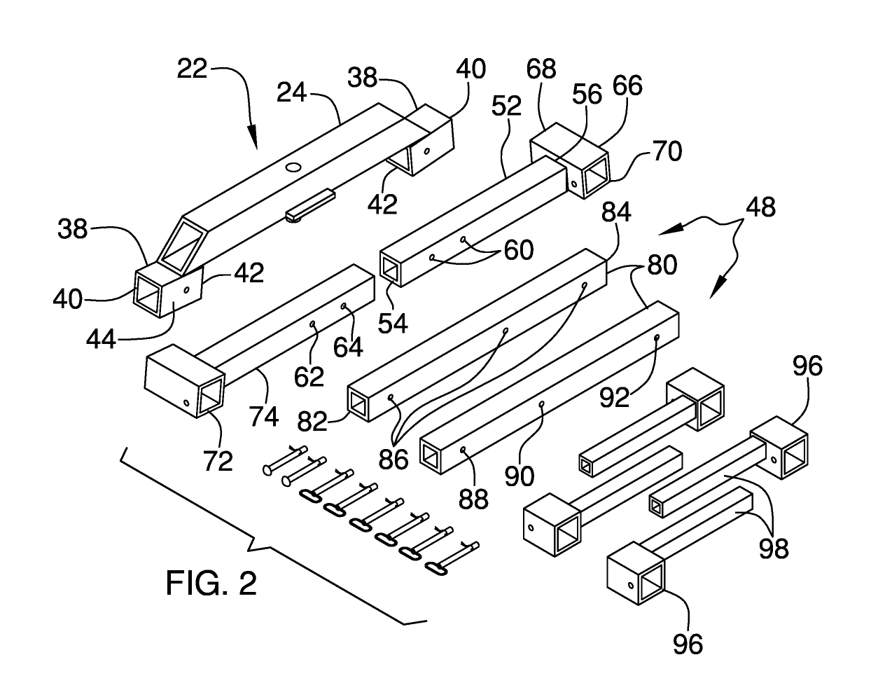

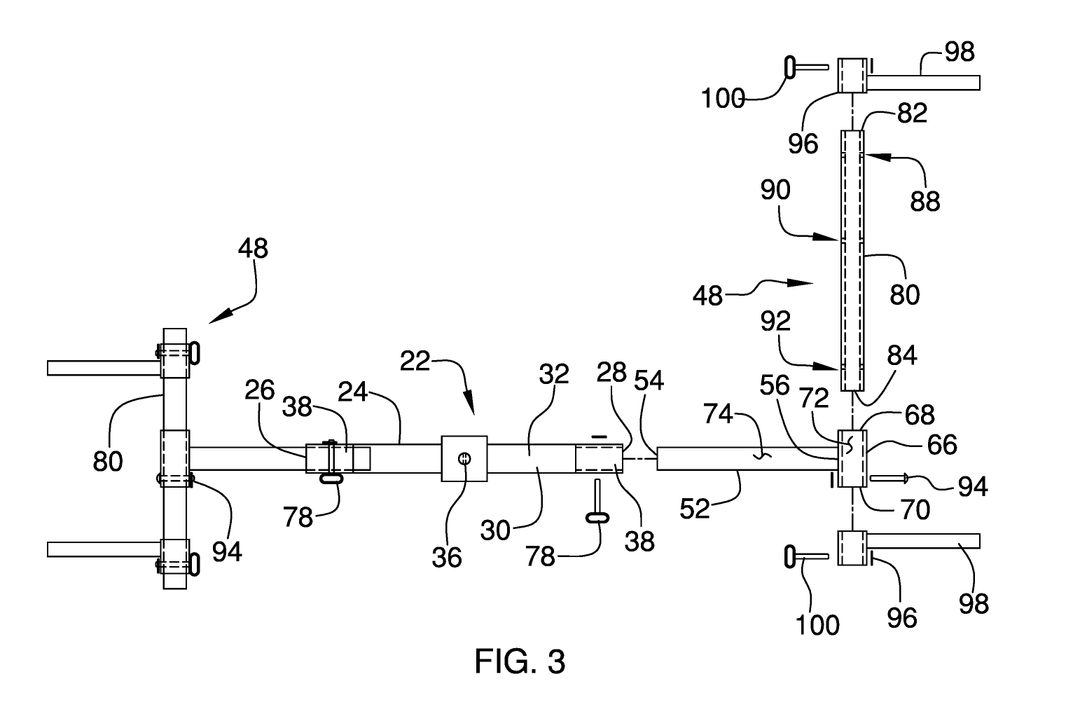

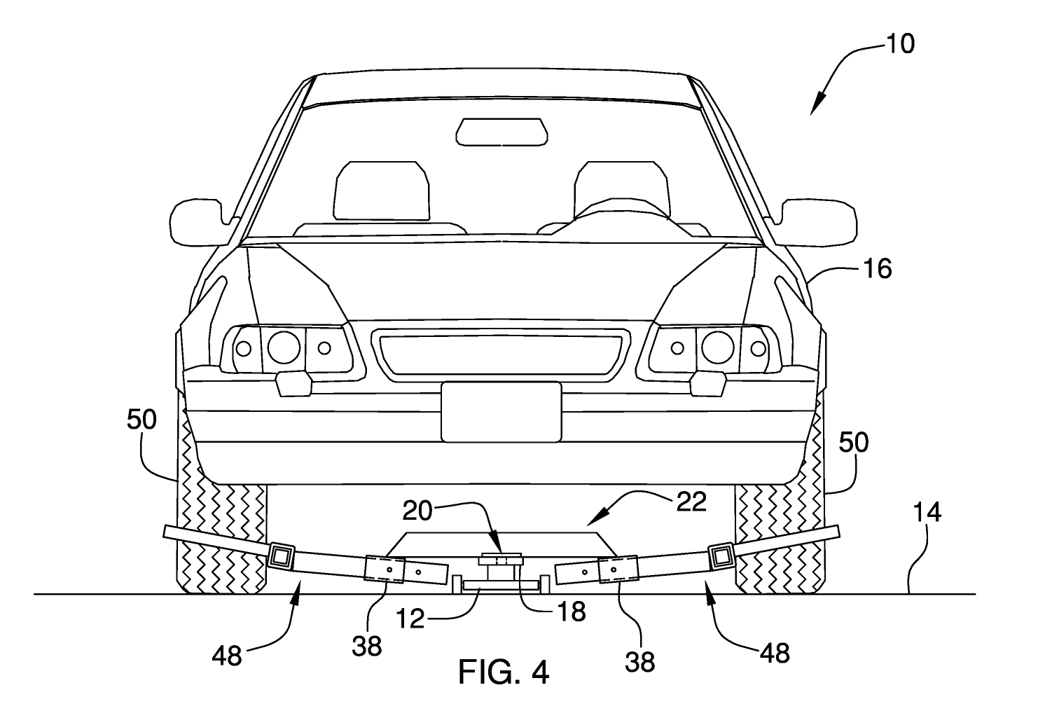

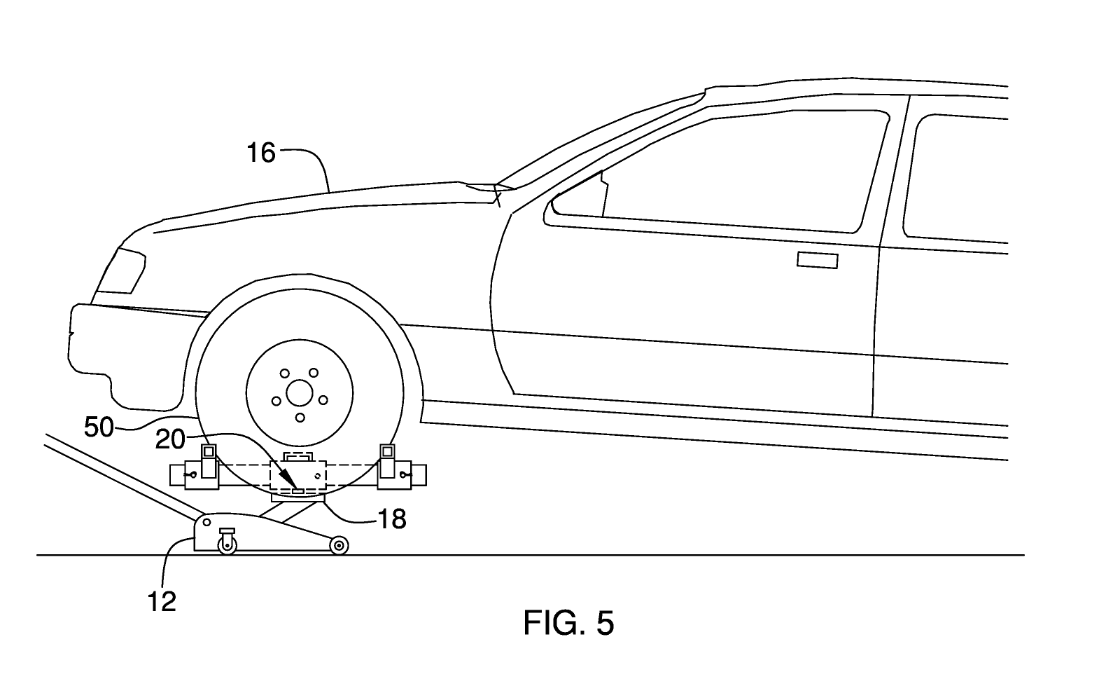

With reference now to the drawings, and in particular to FIGS. 1 through 5 thereof, a new lifting device embodying the principles and concepts of an embodiment of the disclosure and generally designated by the reference numeral 10 will be described.

As best illustrated in FIGS. 1 through 5, the vehicle lifting system 10 generally comprises a jack 12 that may be positioned on a support surface 14 thereby facilitating the jack 12 to be positioned beneath a vehicle 16. The jack 12 is selectively urged between a lifted position and a lowered position. The jack 12 has a lift plate 18 and the lift plate 18 has a hole 20 therein. The jack 12 may be a hydraulic floor jack 12 of any conventional design and the vehicle 16 may be a passenger vehicle or the like that has a transaxle drive train.

A mounting unit 22 is provided and the mounting unit 22 is removably coupled to the jack 12. The mounting unit 22 comprises a member 24 that has a first end 26, a second end 28 and an outer wall 30 extending therebetween. The outer wall 30 has a bottom side 32 and a top side 34, and each of the first end 26 and the second end 28 angles outwardly between the top side 34 and the bottom side 32. The member 24 may have a length ranging between 60.0 cm and 75.0 cm.

A peg 36 is coupled to and extends downwardly from the bottom side 32 and the peg 36 is centrally positioned on the member 24. The peg 36 engages the hole 20 in the lift plate 18 such that the member 24 is removably retained on the jack 12. A pair of first sleeves 38 is provided and each of the first sleeves 38 has a primary end 40, a secondary end 42 and an exterior wall 44 extending therebetween. The exterior wall 44 has an upper side 46 and the upper side 46 corresponding to each of the first sleeves 38 is coupled to the bottom side 32 of the member 24. In this way each of the first sleeves 38 is oriented collinear with the member 24 and each of the first sleeves 38 may have a length ranging between approximately 10.0 cm and 15.0 cm.

Each of the first sleeves 38 is aligned with an associated one of the first end 26 and the second end 28. Moreover, the primary end 40 corresponding to each of the first sleeves 38 is spaced outwardly from the corresponding first 26 and second 28 ends. The upper side 46 corresponding to each of the first sleeves 38 is angled with respect to an axis extending through the first 26 and second 28 ends of the member 24. The upper side 46 corresponding to each of the first sleeves 38 forms an angle of approximately 5.0 degrees with the axis extending through the member 24.

A pair of lifting units 48 is provided and each of the lifting units 48 is removably coupled to the mounting unit 22. Each of the lifting units 48 engages an associated pair of tires 50 on the vehicle 16. In this way the pair of lifting units 48 lifts the vehicle 16 when the jack 12 is urged into the lifting position. Each of the lifting units 48 comprises a primary member 52 that has a first end 54, a second end 56 and an outermost wall 58 extending therebetween. The first end 54 of the primary member 52 is slidably inserted into the primary end 40 corresponding to an associated one of the first sleeves 38. Moreover, the primary member 52 corresponding to each of the lifting units 48 may have a length ranging between approximately 40.0 cm and 45.0 cm.

The outermost wall 58 of the primary member 52 has a pair of first apertures 60 extending therethrough. A first one 62 of the first apertures 60 is spaced from the first end approximately 7 cm. A second one 64 of the first apertures 60 is spaced approximately 15.0 cm from the first end. Each of the lifting units 48 includes a second sleeve 66 that has a primary end 68 and a secondary end 70. The second sleeve 66 is coupled to the second end 56 of the primary member 52 having the second sleeve 66 being oriented transverse with the primary member 52.

A lower surface 72 of the second sleeve 66 is aligned with a bottom surface 74 of the primary member 52. Moreover, the second sleeve 66 is rotated such that an outwardly facing surface 76 of the second sleeve 66 forms an angle of approximately 5.0 degrees with the second end 56 of the primary member 52. A first pin 78 is provided and the first pin 78 is selectively extended through the associated first sleeve 38 with respect to the primary member 52. The first pin 78 engages a selected first one 62 and second one 64 of the first apertures 60 to space the second sleeve 66a selected distance from the primary end 40 of the associated first sleeve 38.

A secondary member 80 is provided that has a first end 82 and a second end 84. The second sleeve 66 slidably receives the secondary member 80. A plurality of second apertures 86 extends through the secondary member 80. A first one 88 of the second apertures 86 is spaced approximately 5.0 cm from the first end 82 of the secondary member 80. A second one 90 of the second apertures 86 is spaced approximately 25.0 from the first end 82 of the secondary member 80. Lastly, a third one 92 of the second apertures 86 is spaced approximately 5.0 cm from the second end 84 of the secondary member 80.

Each of the lifting units 48 includes a second pin 94 that is extended through the second sleeve 66. Moreover, the second pin 94 and engages the second one 90 of the second apertures 86. In this way the primary member 52 is substantially aligned within the second one 90 of the second apertures 86. The secondary member 80 corresponding to each of the lifting units 48 may have a length ranging between approximately 50.0 cm and 65.0 cm.

Each of the lifting units 48 further includes a pair of third sleeves 96 and each of the third sleeves 96 insertably receives an associated one of the first 82 and second 84 ends of the secondary member 80. Each of the lifting units 48 includes a pair of tire bars 98 and each of the tire bars 98 is coupled to an associated one of the third sleeves 96. Moreover, each of the tire bars 98 is oriented perpendicular with the secondary member 80. An associated one of the tires 50 is positioned between the tire bars 98 corresponding to each of the lifting units 48. In this way each of the tire bars 98 corresponding to the lifting units 48 lifts the associated wheel when the jack 12 is urged into the lifting position.

A pair of third pins 100 is provided and each of the third pins 100 is extended through an associated one of the third sleeves 96. Additionally, each of the third pins 100 engages an associated first one 88 and third one 92 of the second apertures 86. In this way the pair of tire bars 98 is spaced apart from each other. Each of the tire bars 98 may have a length ranging between approximately 25.0 cm and 30.0 cm.

In use, the peg 36 on the mounting unit 22 is inserted into the hole 20 in the lift plate 18 to retain the mounting unit 22 on the jack 12. The primary member 52 corresponding to each of the lifting units 48 is inserted into the associated first sleeve 38 on the mounting unit 22. The first pin 78 corresponding to each of the lifting units 48 is extended through the associated first sleeve 38 and engages the selected first one 62 and second one 64 of the first apertures 60. In this way the second sleeve 66 corresponding to each of the lifting units 48 is spaced a selected distance from the mounting unit 22.

The secondary member 80 corresponding to each of the lifting units 48 is extended through the second sleeve 66 of the corresponding lifting unit 48. In this way the secondary member 80 corresponding to each of the lifting units 48 is oriented collinear with the mounting unit 22. The second pin 94 corresponding to each of the lifting units 48 is extended through the second sleeve 66 of the corresponding lifting unit 48 and engages the second one 90 of the second apertures 86 in the secondary member 80. The jack 12 is manipulated to position the mounting unit 22 and each of the lifting units 48 beneath the vehicle 16. Moreover, each of the lifting units 48 is aligned with an associated one of the tires 50 on the vehicle 16.

Each of the third sleeves 96 corresponding to each of the lifting units 48 is slid onto the secondary member 80 of the corresponding lifting unit 48. Each of the third pins 100 corresponding to each of the lifting units 48 is extended through the associated third sleeve 96 and engages an associated first one 88 and third one 92 of the second apertures 86 in the corresponding secondary member 80. In this way each of the tire bars 98 corresponding to each of the lifting units 48 is positioned on opposite sides of the associated tire 50. The jack 12 is manipulated to urge the jack 12 into the lifting position and tire bars 98 corresponding to each of the lifting units 48 lifts the associated tire 50. In this way the vehicle 16 is lifted while leaving pre-determined jack points on the vehicle 16 open for having a jack stand or the like positioned therebeneath.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle lifting system being configured to engage an entire width of a vehicle, said system comprising:
a jack being configured to be positioned on a support surface thereby facilitating said jack to be positioned beneath a vehicle, said jack being selectively urged between a lifted position and a lowered position;
a mounting unit being removably coupled to said jack; and
a pair of lifting units, each of said lifting units being removably coupled to said mounting unit wherein each of said lifting units is configured to engage an associated pair of wheels on the vehicle thereby facilitating said pair of lifting units to lift the vehicle when said jack is urged into said lifting position.

2. The system according to claim 1, wherein said mounting unit comprises a member having a first end, a second end and an outer wall extending therebetween, said outer wall having a bottom side and a top side, each of said first end and said second end angling outwardly between said top side and said bottom side.

3. The system according to claim 2, further comprising:
a lift plate being coupled to said jack, said lift plate having a hole therein; and
a peg being coupled to and extending downwardly from said bottom side, said peg being centrally positioned on said member, said peg engaging said hole in said lift plate such that said member is removably retained on said jack.

4. The system according to claim 2, further comprising a pair of first sleeves, each of said first sleeves having a primary end, a secondary end and an exterior wall extending therebetween, said exterior wall having an upper side, said upper side corresponding to each of said first sleeves being coupled to said bottom side of said member having each of said first sleeves being oriented collinear with said member.

5. The system according to claim 4, wherein each of said first sleeves is aligned with an associated one of said first end and said second end having said primary end corresponding to each of said first sleeves being spaced outwardly from said corresponding first and second ends.

6. The system according to claim 5, wherein said upper side corresponding to each of said first sleeves is angled with respect to an axis extending through said first and second ends of said member.

7. The system according to claim 1, wherein:
said lifting unit includes a pair of first sleeves, each of said first sleeves having a primary end; and
each of said lifting units comprises a primary member having a first end, a second end and an outermost wall extending therebetween, said first end of said primary member being slidably inserted into said primary end corresponding to an associated one of said first sleeves.

8. The system according to claim 7, further comprising a second sleeve having a primary end and a secondary end, said secondary sleeve being coupled to said second end of said primary member having said second sleeve being oriented transverse with said primary member.

9. The system according to claim 8, further comprising a first pin being extended through said associated first sleeve with respect to said primary member and engaging said primary member at a selected point such that said second sleeve is spaced a selected distance from said primary end of said associated first sleeve.

10. The system according to claim 8, further comprising a secondary member having a first end and a second end, said secondary member being slidably positioned in said second sleeve.

11. The system according to claim 10, further comprising a second pin being extended through said second sleeve and engaging said secondary member at a selected point such that said primary member is aligned within said selected point on said secondary member.

12. The system according to claim 10, further comprising a pair of third sleeves, each of said third sleeves insertably receiving an associated one of said first and second ends of said secondary member.

13. The system according to claim 12, further comprising a pair of tire bars, each of said tire bars being coupled to an associated one of said third sleeves having each of said tire bars being oriented perpendicular with said secondary member wherein each of said tire bars is configured to have an associated one of the wheels positioned between said tire bars thereby facilitating each of said tire bars to lift the associated wheel when said jack is urged into said lifting position.

14. The system according to claim 13, further comprising a pair of third pins, each of said third pins being extended through an associated one of said third sleeves and engaging said secondary member at a selected point such that said pair of tire bars is spaced a selected distance apart from each other.

15. A vehicle lifting system being configured to engage an entire width of a vehicle, said system comprising:
a jack being configured to be positioned on a support surface thereby facilitating said jack to be positioned beneath a vehicle, said jack being selectively urged between a lifted position and a lowered position, said jack having a lift plate, said lift plate having a hole therein;
a mounting unit being removably coupled to said jack, said mounting unit comprising:
a member having a first end, a second end and an outer wall extending therebetween, said outer wall having a bottom side and a top side, each of said first end and said second end angling outwardly between said top side and said bottom side,
a peg being coupled to and extending downwardly from said bottom side, said peg being centrally positioned on said member, said peg engaging said hole in said lift plate such that said member is removably retained on said jack, and
a pair of first sleeves, each of said first sleeves having a primary end, a secondary end and an exterior wall extending therebetween, said exterior wall having an upper side, said upper side corresponding to each of said first sleeves being coupled to said bottom side of said member having each of said first sleeves being oriented collinear with said member, each of said first sleeves being aligned with an associated one of said first end and said second end having said primary end corresponding to each of said first sleeves being spaced outwardly from said corresponding first and second ends, said upper side corresponding to each of said first sleeves being angled with respect to an axis extending through said first and second ends of said member; and
a pair of lifting units, each of said lifting units being removably coupled to said mounting unit wherein each of said lifting units is configured to engage an associated pair of wheels on the vehicle thereby facilitating said pair of lifting units to lift the vehicle when said jack is urged into said lifting position, each of said lifting units comprising:
a primary member having a first end, a second end and an outermost wall extending therebetween, said first end of said primary member being slidably inserted into said primary end corresponding to an associated one of said first sleeves,
a second sleeve having a primary end and a secondary end, said secondary sleeve being coupled to said second end of said primary member having said second sleeve being oriented transverse with said primary member,
a first pin being extended through said associated first sleeve with respect to said primary member and engaging said primary member at a selected point such that said second sleeve is spaced a selected distance from said primary end of said associated first sleeve,
a secondary member having a first end and a second end, said secondary member being slidably positioned in said second sleeve,
a second pin being extended through said second sleeve and engaging said secondary member at a selected point such that said primary member is aligned within said selected point on said secondary member,
a pair of third sleeves, each of said third sleeves insertably receiving an associated one of said first and second ends of said secondary member,
a pair of tire bars, each of said tire bars being coupled to an associated one of said third sleeves having each of said tire bars being oriented perpendicular with said secondary member wherein each of said tire bars is configured to have an associated one of the wheels positioned between said tire bars thereby facilitating each of said tire bars to lift the associated wheel when said jack is urged into said lifting position, and
a pair of third pins, each of said third pins being extended through an associated one of said third sleeves and engaging said secondary member at a selected point such that said pair of tire bars is spaced a selected distance apart from each other.
